(19) United States
(12) Patent Application Publication
(10) Pub. No.: US 2026/0297862 A1
(43) Pub. Date: Oct. 1, 2026

(54) ROAD CONSTRUCTION MACHINE FOR SPRAYING ONTO BITUMINOUS VAPORS AS WELL AS METHOD FOR A MATERIAL TRANSFER PROCESS

(71) Applicant: JOSEPH VÖGELE AG, Ludwigshafen/Rhein (DE)

(72) Inventors: Steffen FICKEISEN, Bad Dürkheim (DE); Klaus OETTINGER, Altlußheim (DE)

(73) Assignee: JOSEPH VÖGELE AG, Ludwigshafen/Rhein (DE)

(21) Appl. No.: 19/397,774

(22) Filed: Nov. 21, 2025

(30) Foreign Application Priority Data
Nov. 22, 2024 (EP) 24214844.3

(51) Int. Cl. E01C 19/18; B08B 15/00; E01C 19/10

(52) U.S. Cl. CPC E01C 19/18; B08B 15/00; E01C 2019/1081

(57) ABSTRACT

The disclosure relates to a road construction machine configured in the form of a paving machine or in the form of a feeder vehicle for supplying a paving machine with paving material, wherein the road construction machine comprises a material container for receiving paving material and at least one spraying device for atomizing a liquid. The at least one spraying device is configured for spraying onto bituminous vapors rising from the material container, for spraying onto bituminous vapors rising from a region formed at a material conveyor belt device which transports the paving material in a direction opposite to a direction of travel of the road construction machine from the material container, and/or for spraying onto bituminous vapors rising from a material container of a paving machine trailing the road construction machine.

### CROSS-REFERENCE TO RELATED APPLICATIONS

This application claims foreign priority benefits under 35 U.S.C. § 119(a)-(d) to European patent application number 24214844.3, filed Nov. 22, 2024, which is incorporated by reference in its entirety.

### TECHNICAL FIELD

The present disclosure relates to a road construction machine and to a method for a material transfer process.

### BACKGROUND

EP3276081A1 discloses a paving machine with a spraying device for spraying onto bituminous vapors in the region of the transverse distribution of paving material forward of a screed attached to the paving machine. Spraying onto bituminous vapors in the region of the transverse distribution can prevent aerosols containing bitumen from rising from the region of the transverse distribution to the open operator station of the paving machine. However, vapors containing bitumen that arise at other locations at the paving machine cannot be sprayed onto using the spraying device that is positioned above the transverse distribution arrangement.

### SUMMARY

An object of the disclosure is to improve a road construction machine and a method such that the spread of bituminous vapors can be better prevented using simple design and technical measures.

This object is satisfied by way of a road construction machine according to the disclosure and by way of a method according to the disclosure.

The road construction machine according to the disclosure is present in the form of a paving machine or in the form of a feeder vehicle for supplying a paving machine with paving material. The road construction machine according to the disclosure comprises a material container for receiving paving material and at least one spraying device for atomizing a liquid. The disclosure provides that the spraying device is configured to spray onto bituminous vapors rising from the material container, to spray onto bituminous vapors rising from a region formed on a material conveyor belt device that transports the paving material from the material container in a direction opposite to a direction of travel of the road construction machine, and/or to spray onto bituminous vapors rising from a material container of a paving machine trailing the road construction machine.

For this function, the spraying device according to the disclosure is associated with the material container and/or the material conveyor belt device, where increased vapor development can occur during operation of the road construction machine. Increased vapor development occurs in particular when paving material is transferred into the material container, for example, during a material transfer process using a truck pushed forward of the material container, when the hot paving material is dumped from the truck into the material container. The spraying device according to the disclosure can therefore be used in particular during the material transfer process to suppress the rising bituminous vapors by using the spray mist it injects, for example, a water mist, so that the aerosols contained therein cannot continue to rise to the (driver's) operator station or to the region of other operator stations, for example, the region of a screed operator station.

Increased vapor development in the material container of a paving machine also occurs in particular when the paving machine is loaded by a feeder vehicle that is driving ahead when the hot paving material drops from the feeder vehicle into the material container of the paving machine. The spraying device according to the disclosure can also be used effectively to suppress the vapors arising during the loading process.

Furthermore, the spraying device according to the disclosure can be used to spray onto vapors arising when the paving material stored in the material container is mixed, i.e., regardless of whether a material transfer process is taking place.

Consequently, the spraying device according to the disclosure can be used for various scenarios during construction operations to effectively keep vapors away from operating staff by spraying onto bituminous vapors at locations where increased vapor creation occurs.

The spraying device preferably comprises at least one nozzle formed directly on or attached to the material hopper. The nozzle can be supplied with a liquid, such as water, through a wall of the material container, for example, through a line routed therein. It would be conceivable for the nozzle to be arranged on an upper edge of the material container, in particular on the upper edge of a tiltable hopper half of the material container, preferably structurally integrated therein.

According to one embodiment of the disclosure, the material container is configured as a detachable attachment container or as a material hopper with tiltable hopper halves that is installed permanently on the road construction machine. As an attachment container, the material container is configured to hold a larger quantity of paving material. For this purpose, the attachment container can be equipped with higher side walls than a material hopper that is present on the road construction machine into which the attachment container is inserted.

One variant provides that the material container, in particular when it is present as an attachment container, forms the spraying device at least in part, whereby the spraying device can be powered by a generator of the road construction machine or be battery-operated. According to one variant, all liquid lines of the spraying device can be routed at the material container, in particular within a double wall provided thereon.

It would be conceivable for the attachment container to have a rear wall which faces the operator station of the road construction machine and at which at least one nozzle of the spraying device is arranged. A spray pattern of atomized liquid from the rear wall of the attachment container can be formed like a blanket over the paving material that is dropping into the attachment container in order to cover any vapors created and prevent them from rising from the attachment container.

One variant provides for the spraying device to have at least one nozzle attached to an engine hood of the road construction machine. This nozzle can be received in an opening formed in the engine hood for this purpose. The nozzle is provided in particular on a vertical section of the engine hood facing the material hopper and projecting thereabove. This allows for spraying an atomized liquid onto the bituminous vapors rising in the material hopper. In particular, the nozzle formed in the engine hood can be positioned such that the spray pattern it creates is produced just above the material hopper in order to cover the vapors rising therein before they emerge from the material hopper.

According to one embodiment, the nozzle is configured as a fan nozzle. Such a nozzle can be arranged directly on the material container or accommodated within a slot formed in the engine hood above the material hopper. This allows for a horizontal spray mist as the spray pattern to be produced above the paving material received.

It is advantageous to have the nozzle be provided on the material container and/or on the engine hood such that the liquid injected is captured by a cooling air flow flowing out of the engine hood and distributed in regions over the material container to create an enlarged mist field for suppressing rising vapors.

It is particularly helpful to have the nozzle be usable to create a spray pattern that is disposed below a cooling air flow emerging from the engine hood above the material container in the direction of travel. The misting created by the nozzle, together with the cooling air flow disposed thereabove, can lead to increased shielding of the vapors.

The spraying device preferably comprises at least one adjustable nozzle for forming different spray patterns and/or for forming different directions of flow. It would be conceivable for the nozzle to adjust in an automated manner as a function of the position of the material hopper halves. In this case, it would be conceivable to adjust the spray width of the spray pattern produced thereby and/or to adjust its orientation in order to avoid spraying against the tilted material hopper halves or to enable horizontal spraying even when the hopper halves are tilted.

According to one embodiment of the disclosure, the spraying device comprises at least one tank for holding a liquid as well as a pump which are either received within an engine compartment of the road construction machine or are attached to the road construction machine as a retrofit kit that can be detachably attached without the need for tools. In an embodiment in which the material container is present as an attachment container, the tank and the pump of the spraying device can be integrated into the attachment container, i.e., be present as components of the attachment container. In this variant, it would be conceivable for the capacity volume of the tank to be delimited at least in part by a wall of the attachment container.

The spraying device preferably disposes of a tank for holding a liquid, in particular water, which is used for spraying onto the bituminous vapors, and disposes of a separate tank for holding another liquid, for example, a cleaning agent, which is not used for spraying onto the bituminous vapors.

It would be expedient to drive the spraying device by way of an energy supply of the road construction machine. Alternatively, an independent energy supply would be conceivable. For example, the spraying device is powered by a generator of the road construction machine or is formed to be battery-operated.

According to one embodiment, it is provided that the material conveyor belt device is present as a longitudinal conveyor device of the paving machine or as a pivoting conveyor device of the feeder vehicle, wherein the spraying device is configured to spray onto a transfer region formed between successively arranged conveyor belts of the pivoting conveyor device and/or to spray onto a discharge region formed at the outlet of the conveyor belt of the pivoting conveyor device formed as a discharge belt. At such material transfer regions, increased vapor development can occur at a feeder vehicle because the paving material there has a certain drop height in order to be transported onward.

The spraying device preferably comprises a temperature control unit for tempering, in particular for cooling, the spray liquid and/or a measuring device for detecting aerosol load in at least one of the sprayable regions. Using actively cooled liquid, a spray mist can be produced which allows for the vapors to cool more quickly, i.e., the aerosols contained therein can be better bound. The aerosol load can be detected, for example, by way of an optical measuring device, in particular a measuring device attached directly to the material container. It is conceivable to have the measuring device be used to detect air humidity in the surrounding of the road construction machine, and, as a function thereof, be able to adjust a spraying performance of the spraying device.

It is conceivable for the measuring device to be present as part of a mobile control unit for the spraying device. However, a mobile control unit for the spraying device that is not equipped with a measuring device would also be conceivable.

It would be conceivable for the spraying device to be a drone, i.e., formed by at least one unmanned aerial vehicle. This drone can also be used in addition to a spraying device that is used in a stationary manner at the road construction machine. The spraying device in the form of a drone can be employed at various locations on the road construction machine and even on different road construction machines in a paving train, in order to primarily spray onto the bituminous vapors rising from the material container using a liquid stored in the drone.

It would be conceivable for the drone to be parked beneath the roof of the road construction machine, e.g., in a (loading) station provided there, and to be used during a material transfer process, in particular when a truck pours paving material into the material container of the road construction machine, or during a continuous feeding process, to spray onto the bituminous vapors rising from the material container.

According to one variant, measurements, as a function of which spraying can be carried out by the drone, can be performed directly by the drone, even when it is parked beneath the roof. For example, the drone can be configured to detect aerosol load in the region of the material container.

It would be conceivable for the spraying device to comprise at least one hose reel as well as a nozzle that can be connected to or is connected to a hose received on the hose reel. The hose can be drawn out from the hose reel, which is located, for example, in the engine compartment, far enough so that the nozzle can be attached to a desired location in the region of the material container, for example, using a quick-release fastener without the need for tools, preferably directly at the upper edge of the material container. This nozzle can also be used as a cleaning nozzle to clean the road construction machine after termination of operation by the road construction machine, i.e., after a paving or feeding run. For this purpose, the nozzle can be configured to create various spray patterns. For cleaning purposes, the spraying device can use a cleaning agent stored in a separate tank. However, the cleaning agent is not used for being sprayed onto the bituminous vapors. Instead, a different liquid is used for this purpose, such as water, which is stored in a water tank of the spraying device.

According to one variant, the hose can be drawn off far enough from the hose reel to be able to be connected to a nozzle arranged on the attachment container, in particular to a nozzle integrally installed thereon. In this variant, the attachment container provides the nozzle for connecting to components of the spraying device that would otherwise be arranged separately from the attachment container on the road construction machine.

It is conceivable for the spraying device to be supplied with spraying liquid by a tank vehicle accompanying the road construction machine. The road construction machine and the tank vehicle can travel side by side in the paving direction.

According to one variant, the spraying device comprises at least one nozzle for spraying onto an exhaust air flow generated from extracted bituminous vapors. In particular, this nozzle can be used on a discharge side of a ventilation system that generates overpressure for spraying onto the exhaust air flow emitted at the outlet of the ventilation system. The extracted vapors originate in particular from a transverse distribution region forward of the screed.

Furthermore, the disclosure relates to a paving train comprising at least one road construction machine according to the disclosure, in particular at least one paving machine according to the disclosure and at least one feeder vehicle, in particular a feeder vehicle according to the disclosure, that is traveling in the direction of production ahead of the paving machine and supplying it with paving material. In such a paving train, the respective participants, i.e., both the paving machine as well as the feeder vehicle that is travelling ahead, can preferably be equipped with a spraying device according to the disclosure for spraying atomized liquid onto bituminous vapors rising from the respective material containers of these vehicles.

The spraying device of the feeder vehicle that is travelling ahead can be configured in particular on the discharge belt in such a way that it can spray onto the bituminous vapors rising from the material container of the trailing paving machine. This paving machine would then be able to operate even without its own spraying device to suppress the vapors from the material container, i.e., prevent them from spreading further along the paving machine.

One variant provides for at least one spraying device configured as a drone to be used at the paving train to spray atomized liquid at least onto the vapors rising from the material containers. This can be done, for example, alternately between the vehicles, depending on which vehicle in the paving train has the highest vapor load.

The disclosure further relates to a method for a material transfer process for supplying a paving machine and/or a feeder vehicle with paving material. According to the disclosure, an atomized liquid is sprayed during the material transfer process at least temporarily onto bituminous vapors rising from a material container of the paving machine and/or feeder vehicle and/or from a region formed on a material conveyor belt device that transports the paving material out of the material container. During the material transfer process, in particular where paving material is transferred between vehicles, is, for example, dumped from a truck into a feeder vehicle or directly from a truck into a paving machine, the bituminous vapor development in the region of the material container is particularly intense so that spraying onto the resulting vapors is effective in preventing them from spreading.

For spraying onto rising bituminous vapors, preferably at least one spraying device arranged on the paving machine, at least one spraying device is arranged on the feeder vehicle, and/or at least one drone is used.

It would be conceivable in a paving train for the spraying device configured as a drone to move following an automated flight trajectory, where it is located in the region of the material container of the feeder vehicle when paving material is being dumped thereinto from a truck, in order to spray onto the increased vapor development at this material container caused by the dumping of the paving material, for example, as long as the truck is being pushed by a push bar of the feeder vehicle, where the drone would thereafter automatically fly in a direction opposite to the direction of production of the paving train to an region where paving material drops from a discharge belt of the feeder vehicle into the material container of the trailing paving machine, in order to spray onto the bituminous vapors rising from the material container of the paving machine.

One variant provides for the drone to act as a helper drone to support a spraying device used on the paving machine and/or the feeder vehicle to spray onto vapors from the material container, in particular when increased vapor development occurs there.

### BRIEF DESCRIPTION OF THE DRAWINGS

Embodiments according to the disclosure shall be explained in more detail with reference to the following figures, where:

FIG. 1 shows a road construction machine in the form of a paving machine with a spraying device;

FIG. 2 shows a road construction machine in the form of a paving machine with a spraying device configured as a drone;

FIG. 3 shows a partial front view of a paving machine with the material hopper halves folded up;

FIG. 4 shows a road construction machine in the form of a paving machine with an attachment container in the material hopper;

FIG. 5 shows a road construction machine in the form of a feeder vehicle with a spraying device; and

FIG. 6 shows a road construction machine in the form of a feeder vehicle with a spraying device.

Identical technical features are provided with the same reference numerals throughout the figures.

### DETAILED DESCRIPTION

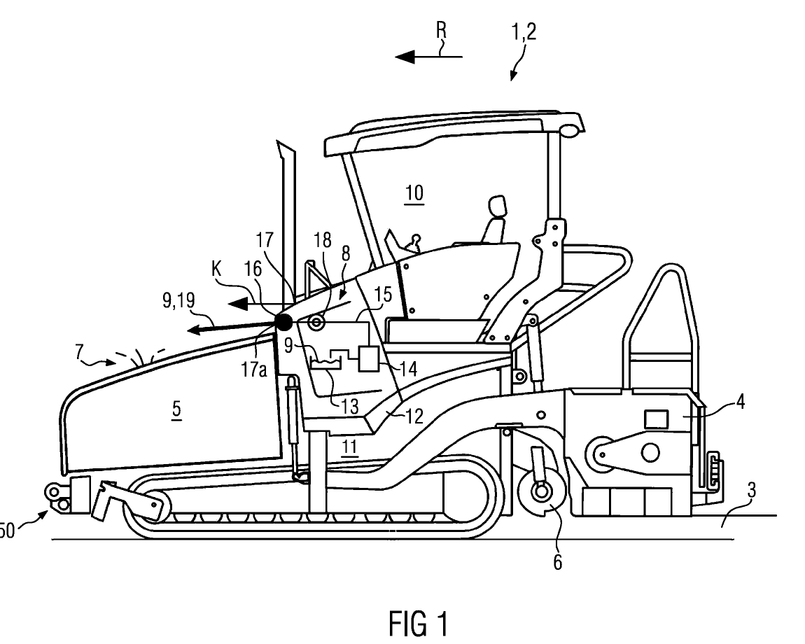

FIG. 1 shows a road construction machine 1 configured as a paving machine 2 for producing a new pavement layer 3. To produce pavement layer 3, paving machine 2 comprises a screed 4 that is supplied with paving material from a material container 5 The paving material is transported from material container 5 in the direction opposite to a direction of travel R of paving machine 2 by way of a material conveyor belt device (not shown), which is present as a longitudinal conveyor device below the driver operator station, to a transverse distribution auger 6 mounted forward of screed 4 where it is spread. According to FIG. 1, material container 5 is configured as a material hopper at paving machine 2.

Vapors 7 containing bituminous aerosols rise from material container 5. Paving machine 2 from FIG. 1 comprises a spraying device 8 that is configured to spray an atomized liquid 9 onto vapors 7. This can be water mist to suppress or fog up the aerosols contained in vapors 7. With the resulting increase in droplet formation, the bituminous aerosols contained in vapors 7 that rise from material container 5 can be bound, whereby it is possible to prevent them from spreading further, and it can be prevented in particular that they float up to an operator station 10 of paving machine 2.

According to FIG. 1, spraying device 8 is installed within an engine compartment 11 of paving machine 2. Alternatively, modular mounting could be considered, according to which spraying device 8 is present as a modular retrofit kit, i.e., as a module that is detachably attached to paving machine 2 in the region of material container 5 and is suitable for autonomous operation.

Furthermore, FIG. 1 shows a side panel 12 of engine compartment 11 which can be opened like a door to gain access to spraying device 8. Spraying device 8 includes a tank 13 for holding liquid 9, for example, a water tank. Furthermore, spraying device 8 includes a pump 14 that is configured to pump liquid 9 from tank 13 and convey it through a line 15 to a nozzle 16 that is configured as an atomizer nozzle, in particular as a flat nozzle or fan nozzle, respectively.

Nozzle 16 from FIG. 1 is arranged at an engine hood 17, in particular on a vertical section 17a of engine hood 17, such that atomized liquid 9 can be sprayed in direction of travel R above material container 5.

According to FIG. 1, spraying device 8 comprises a hose reel 18 that is positioned within engine compartment 11. Hose reel 18 is connected to pump 14 by way of line 15. Due to hose reel 18, nozzle 16 can be drawn out from hood 17, for example, to be able to be used for cleaning paving machine 2. Alternatively, spraying device 8 shown in FIG. 1 can also be configured without a hose reel 18 in a simplified structure so that nozzle 16 is permanently installed in hood 17 or is fixedly arranged thereon.

According to FIG. 1, a spray pattern 19 formed from atomized liquid 9 can be formed below a cooling air flow K flowing out from engine hood 17. This can further enhance the effect of keeping vapors 7 away from operator station 10. Cooling air flow K can be directed in direction of travel R by way of at least one flow rib formed in hood 17 so that it covers spray pattern 19.

For a material transfer process, paving machine 2 includes a push bar 50 onto which an idling truck can dock with its rear tires for dumping paving material into material container 5. During the material transfer process, the truck can be pushed by paving machine 2 in direction of travel R.

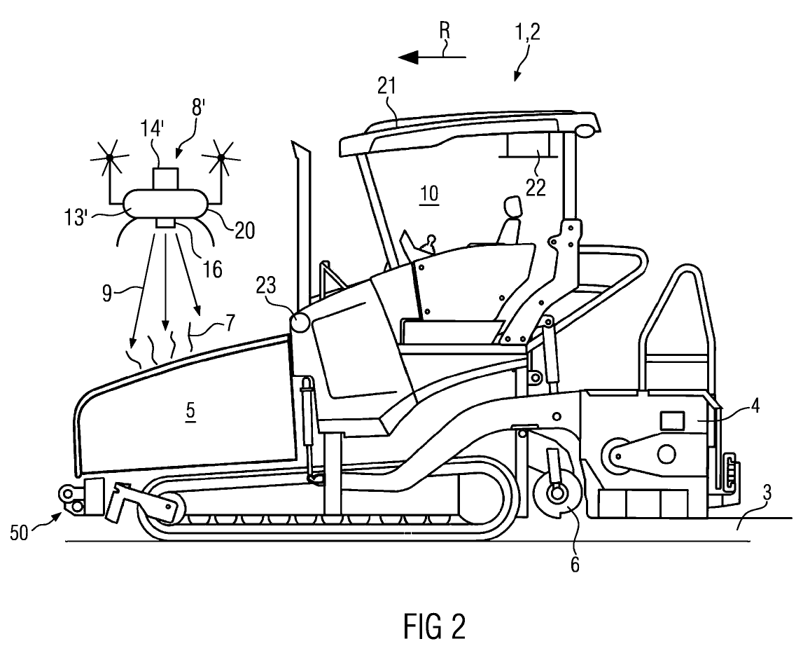

FIG. 2 shows road construction machine 1 in the form of a paving machine 2 with a spraying device 8' which is present as a drone 20. Drone 20 includes a tank 13' with liquid 9 as well as at least one nozzle 16 for atomizing liquid 9. Drone 20 is equipped with a pump 14' to convey liquid 9 from tank 13' to nozzle 16.

Drone 20 can fly above material container 5, in particular during the material transfer process, in order to spray atomized liquid 9 onto rising vapors 7 from above so that bituminous aerosols contained in vapors 7 are bound with increasing droplet formation, i.e., they cannot spread further.

Spraying device 8', in FIG. 2 configured in the form of a drone 20, can be used as a helper drone in addition to spraying device 8 shown in FIG. 1. A station 22 for drone 20 at paving machine 2 from FIG. 2 is provided on a roof 21 of the paving machine, which station is in particular present as a charging station. Drone 20 can remain therein when it is not needed for spraying onto vapors 7. However, drone 20 leaves station 22 when it is needed, for example, as a helper drone to support spraying device 8.

Furthermore, FIG. 2 shows a measuring device 23 that is arranged in the region of material container 5 for detecting an aerosol load from rising vapors 7. Measuring device 23 can be located on engine hood 17 of paving machine 2. Alternatively, drone 20 can comprise measuring device 23 for detecting an aerosol load from rising vapors 7.

The use of spraying device 8' from FIG. 2, present as drone 20, and/or the use of spraying device 8 shown in FIG. 1 can be controlled based on the measured values of measuring device 23. Measuring device 23 can also be configured to detect air humidity so that, if the detected air humidity is relatively high, drone 20 is not employed for spraying onto rising vapors 7.

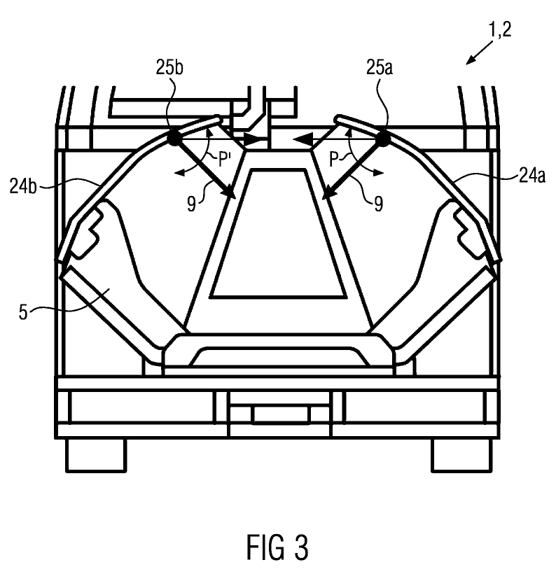

The front view in FIG. 3 shows material hopper halves 24a, 24b of material container 5 which are folded up to shift paving material from the side regions towards the center. Material hopper halves 24a, 24b comprise nozzles 25a, 25b by way of which atomized liquid 9 can be injected into the receiving region of material container 5. Respective double arrows P, P' in FIG. 3 schematically show that nozzles 25a, 25b can be adjusted to maintain horizontal injection of atomized liquid 9, in particular, they can be adjusted in an automated manner to better prevent bituminous aerosols from rising from material container 5.

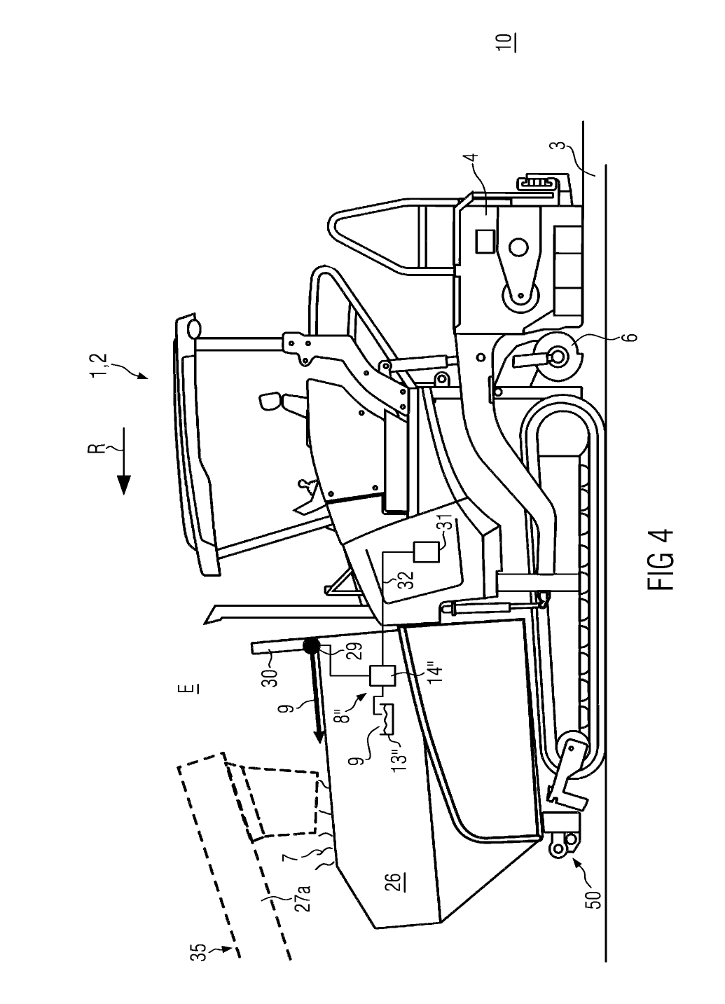

FIG. 4 shows paving machine 2 in which material container 5 is present as an attachment container 26 which is inserted into the material hopper of paving machine 2. Due to its raised side walls compared to the material hopper, attachment container 26 is suitable for receiving a larger quantity of paving material.

Paving material drops into attachment container 26 from a discharge belt 27a configured as a pivoting conveyor of a feeder vehicle 35 that is driving ahead so that vapors 7 arise in the discharge region.

Attachment container 26 is configured as a spraying device 8'' according to FIG. 4 for spraying onto vapors 7 rising therefrom. For this purpose, attachment container 26 comprises a nozzle 29, which, as shown in FIG. 4, is formed in a rear wall 30 of attachment container 26. Spraying device 8'' formed by attachment container 26 is supplied with power by a generator 31 of paving machine 2 by way of an electrical line 32. A pump 14'' integrated into attachment container 26 according to FIG. 4 can be electrically operated by way of line 32 using generator 31 in order to convey liquid 9 from a tank 13'', that is provided at attachment container 26, to nozzle 29.

It would be conceivable for attachment container 26 to be present without spraying device 8'', where vapors 7 rising therefrom are sprayed onto using drone 20 shown in FIG. 2 and/or nozzle 16 connected to hose reel 18 is drawn out from hood 17 and attached to attachment container 26 at its rear wall 30 for spraying onto vapors.

It would be imaginable to have nozzle 29 provided in attachment container 26 be connectable to the hose of hose reel 18, i.e., spraying device 8 from FIG. 1 is connectable to nozzle 29 of attachment container 26 for spraying onto vapors 7.

FIG. 5 shows road construction machine 1 in the form of a feeder vehicle 35 which is configured for supplying paving material to a paving machine 2 that is trailing in direction of travel R thus forming a paving train E (see FIG. 4).

Feeder vehicle 35 from FIG. 5 comprises a material container 5'. The paving material is transported from material container 5' in a direction opposite to direction of travel R of feeder vehicle 35 by way of a material conveyor belt device which is present in the form of a pivoting conveyor device. The material conveyor belt device of feeder vehicle 35 comprises a conveyor belt 27b from which the paving material is transported out of material hopper 5' and transferred to a discharge belt 27a configured as a pivoting belt. Atomized liquid 9 can be sprayed by way of a spraying device 8''' provided on feeder vehicle 35 onto vapors 7 rising from material container 5', in particular when a truck that is pushed by push bar 50' dumps paving material into material container 5'.

According to FIG. 5, spraying device 8''' is also configured to spray atomized liquid 9 onto a transfer region 40 formed between conveyor belt 27b and discharge belt 27a configured as a pivoting belt, since increased vapor development can also occur there.

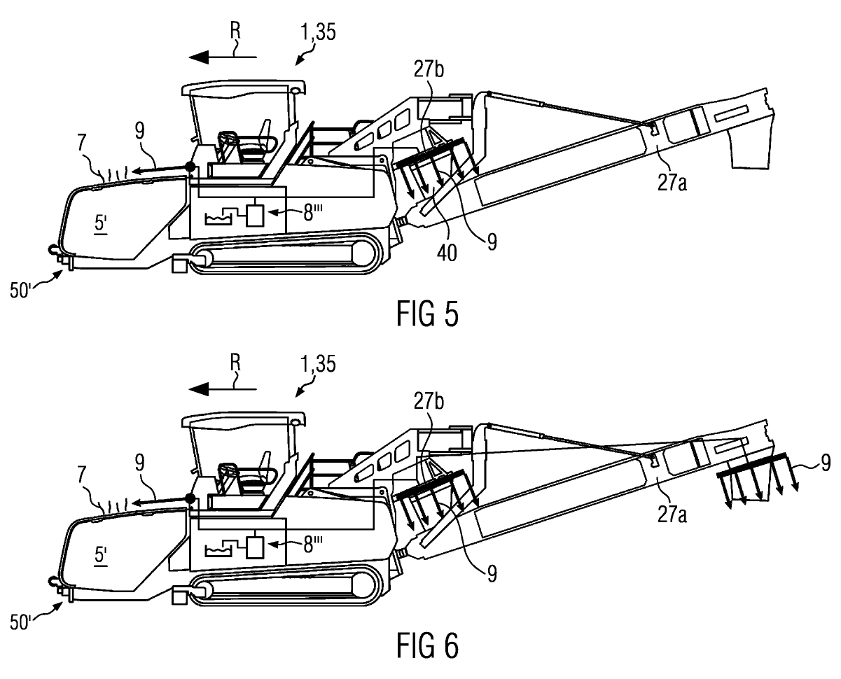

Furthermore, according to an embodiment shown in FIG. 6, spraying device 8''' can be configured to inject atomized liquid 9 at an outlet of discharge belt 27a for spraying onto vapors 7 existing there and which rise from material container 5 of a trailing paving machine 2.

What is claimed is:

1. A road construction machine configured as a paving machine or a feeder vehicle for supplying a paving machine with paving material, wherein the road construction machine comprises a material container for receiving paving material and at least one spraying device for atomizing a liquid, wherein the at least one spraying device is configured to
a) spray onto bituminous vapors rising from the material container,
b) spray onto bituminous vapors rising from a region formed on a material conveyor belt device which transports the paving material from the material container in a direction opposite to a direction of travel of the road construction machine, and/or
c) spray onto bituminous vapors rising from a material container of a paving machine trailing the road construction machine.

2. The road construction machine according to claim 1, wherein the at least one spraying device comprises at least one nozzle formed directly on and/or attached to the material container.

3. The road construction machine according to claim 1, wherein the material container of the road construction machine is configured as a detachable attachment container or a material hopper with tiltable hopper halves that is permanently installed on a portion of the road construction machine.

4. The road construction machine according to claim 1, wherein the at least one spraying device comprises at least one nozzle attached to an engine hood of the road construction machine.

5. The road construction machine according to claim 4, wherein the at least one nozzle is configured to create a spray pattern disposed below a cooling air flow exiting the engine hood in the direction of travel above the material container.

6. The road construction machine according to claim 1, wherein the at least one spraying device comprises at least one nozzle that is adjustable for forming different spray patterns and/or for forming different directions of flow.

7. The road construction machine according to claim 1, wherein the at least one spraying device comprises at least one tank and a pump which are either accommodated within an engine compartment of the road construction machine or are detachably attached to a portion of the road construction machine as a retrofit kit without the need for tools.

8. The road construction machine according to claim 1, wherein the at least one spraying device is drivable by way of an energy supply of the road construction machine or has an independent energy supply.

9. The road construction machine according to claim 1, wherein the material conveyor belt device is configured as a longitudinal conveyor device of the paving machine or as a pivoting conveyor device of the feeder vehicle, wherein the at least one spraying device is configured to spray onto a transfer region formed between successively arranged conveyor belts of the pivoting conveyor device and/or is configured to spray onto a discharge region formed at an outlet of one of the conveyor belts of the pivoting conveyor device configured as a discharge belt.

10. The road construction machine according to claim 1, wherein the at least one spraying device comprises a temperature control unit for tempering temperature of the liquid and/or a measuring device for detecting an aerosol load in at least one sprayable region.

11. The road construction machine according to claim 1, wherein one of the at least one spraying device is configured as a drone.

12. The road construction machine according to claim 1, wherein one of the at least one spraying device comprises a hose reel as well as a nozzle connected to a hose received on the hose reel.

13. A paving train comprising at least one road construction machine according to claim 1.

14. The paving train according to claim 13, wherein the at least one road construction machine comprises two of the road construction machines, and wherein one of the road construction machines is configured as the paving machine and the other of the road construction machines is configured as the feeder vehicle traveling in the direction of production ahead of the paving machine for supplying the paving machine with paving material.

15. A method for a material transfer process for supplying a paving machine and/or a feeder vehicle with paving material, the method comprising spraying atomized liquid during the material transfer process at least temporarily onto bituminous vapors rising from a material container of the paving machine and/or of the feeder vehicle and/or from a region formed at a material conveyor belt device that transports the paving material out of the material container.

16. The method according to claim 15, wherein
a. at least one spraying device arranged on the paving machine,
b. at least one spraying device arranged on the feeder vehicle, and/or
c. at least one spraying device configured as a drone are/is used to spray the atomized liquid during the material transfer process.
